(19) United States
(12) Patent Application Publication
(10) Pub. No.: US 2016/0189897 A1
(43) Pub. Date: Jun. 30, 2016

(54) Protection Device

(71) Applicant: TYCO ELECTRONICS JAPAN G.K., Kanagawa (JP)

(72) Inventors: Takashi Hasunuma, Narita City (JP); Arata Tanaka, Ryugasaki (JP); Toshikazu Yamaoka, Ibaraki (JP)

(73) Assignee: Tyco Electronics Japan G.K., Kawasaki-shi, Kanagawa (JP)

(21) Appl. No.: 14/907,809

(22) PCT Filed: Jul. 17, 2014
(86) PCT No.: PCT/JP2014/069038

§ 371 Date: Feb. 10, 2016

(30) Foreign Application Priority Data
Jul. 26, 2013 (JP) 2013.155462

(51) Int. Cl. H01H 37/76

(52) U.S. Cl. CPC H01H 37/761

(57) ABSTRACT

An object of the present invention is to provide a protection device which is able to provide suitable protection against excessive current and the abnormal high temperature, has large holding current and does not have mechanical contact. The present invention provides a protection device including (i) at least one PTC component and (ii) a thermal fuse component, wherein each PTC component and the thermal fuse component are connected to each other electrically in parallel; the thermal fuse component is under the influence of heat of at least one PTC component; and in a normal state, a current flows substantially through each PTC component and the thermal fuse component.

### TECHNICAL FIELD

The present invention relates to a protection device.

### BACKGROUND ART

In various electrical circuits, a protection component or a protection device is installed in each of the circuits in order to protect an electrical or an electronic apparatus and/or an electrical or an electronic part which are installed in the circuit or an electrical, or an electronic circuit when an abnormal state occurs, for example when a current larger than a rated current flows.

As such a protection component, for example, a PTC (positive temperature coefficient) component, a thermal fuse component, a current fuse component and the like are known which provide protection against an excessive current or an abnormal high temperature.

Additionally, it is suggested as the protection device to use a bimetal switch and the PTC component in a state of being connected in parallel (Patent Document 1). In such a protection device, when an excessive current condition occurs, a bimetal part of the bimetal switch becomes a high temperature and its contacts separate and open, and thereby diverting the current to the PTC component. As a result, the PTC component trips and becomes a high temperature and a high resistance state due to the excessive current, and thereby substantively interrupts the current flowing therethrough.

### PRIOR ART DOCUMENT

### Patent Document

Patent Document 1: International Publication No. WO 2008/114650

### SUMMARY OF THE INVENTION

### Problem to be Solved by the Invention

Among the protection components described above, the PTC component generally has a holding current which is not so large and it is not necessarily suitable for using in a high-capacity battery, for example in a personal computer. In addition, since a PTC component generally has a relatively high trip temperature, for example, the trip temperature over 100° C., it is not necessarily easy to provide the suitable protection when the abnormal high temperature is a relatively low temperature, for example 80° C.

The thermal fuse component can provide the suitable protection against the abnormal high temperature with high sensitivity even when it is relatively low, while the thermal fuse component does not have so high sensitivity against the excessive current and requires a time to fuse, therefore, it is not be necessarily easy to provide the suitable protection. In addition, variation in fusing property of each component against a high capacity, in particular a current value over 6 A, is large, and therefore the suitable protection cannot be necessarily provided.

The current fuse component can provide the suitable protection against the excessive current, but cannot necessarily easily provide the suitable protection against the abnormal high temperature. In addition, with respect to the protection against the excessive current, it is not necessarily easy to provide a rapid and sure protection against an excessive current which does not so largely exceed a rated current, for example, an excessive current which is twice the rated current.

The protection device which is a combination of the bimetal switch and the PTC component as described in Patent Document 1 can have a large holding current and good protection properties such as sensitivity. However, since it has a mechanical contact system, it has problems in that a contact failure due to corrosion, an instantaneous interruption due to an impact and the like occur.

An object to be solved by the present invention is therefore to provide a protection device which is able to provide the suitable protection against the excessive current and the abnormal high temperature, has the large holding current and does not have a mechanical contact.

### Means to Solve the Problem

In the first aspect, the present invention provides a protection device comprising
(i) at least one PTC component, and
(ii) a thermal fuse component,
   wherein
each of the PTC component and the thermal fuse component are connected to each other electrically in parallel,
the thermal fuse component is under influence of heat of at least one PTC component, and
in a normal state, a current flows substantially through each PTC component and the thermal fuse component.

In the second aspect, the present invention provides an electrical apparatus comprising the protection device described above.

### Effect of the Invention

The protection device of the present invention can provide the suitable protection against both the excessive current and the abnormal high temperature and also have the large holding current by connecting the PTC component and the thermal fuse component electrically in parallel with each other, and disposing the thermal fuse component such that it is under the influence of heat of the PTC component, so that the current is divided into the PTC component and the thermal fuse component. In addition, since the protection device of the present invention does not have a mechanical contact, the protection device of the present invention does not cause the contact failure due to its corrosion or the instantaneous interruption due to an impact, so that it has excellent environmental resistance and excellent impact resistance.

### BRIEF DESCRIPTION OF THE DRAWINGS

FIG. 1 shows a circuit diagram in one embodiment of the protection device of the present invention.

FIG. 2 shows a circuit diagram in other embodiment of the protection device of the present invention.

### EMBODIMENTS TO CARRY OUT THE INVENTION

The protection device of the present invention will be described below in detail with reference to the drawings. It is noted that the protection device of the present invention is not limited to the illustrated embodiments.

In the present specification, a “holding current” means a maximum current which is able to flow without activation of the thermal fuse component, the PTC component or the protection device.

In the present specification, a “rated current” means a maximum current with which the thermal fuse component, the PTC component or the protection device can be safely used, and it is generally set by a manufacturer.

In the present specification, an “activating current” means a minimum current with which the thermal fuse component, the PTC component or the protection device activates.

In the present specification, an “activating temperature” means a minimum temperature at which the thermal fuse component, the PTC component or the protection device activates.

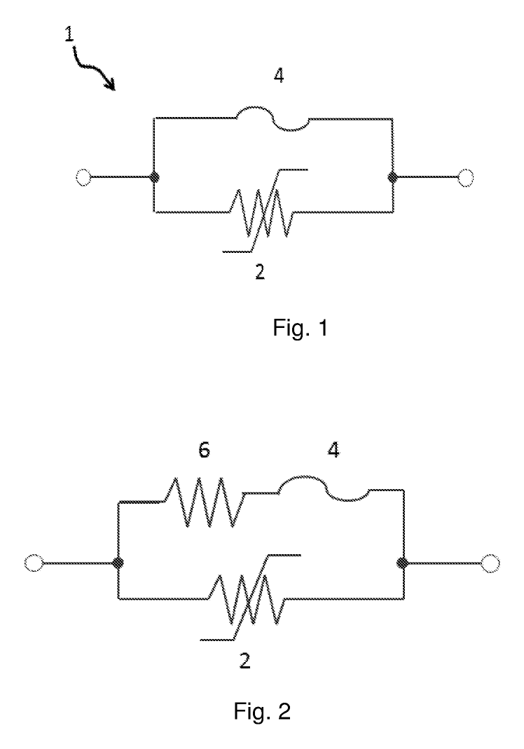

A circuit diagram corresponding to one embodiment of the protection device of the present invention is shown in FIG. 1. As shown in FIG. 1, the protection device 1 of the present invention comprises a PTC component 2 and a thermal fuse component 4. The PTC component 2 and the thermal fuse component 4 are connected electrically in parallel with each other, and the thermal fuse component is under the influence of heat of the PTC component. In a normal state, a current flowing through the protection device 1 is divided into the PTC component 2 and the thermal fuse component 4 and flows substantively through the PTC component and the thermal fuse component. Here, the “normal state” means that an abnormal state such as an excessive current or an abnormal heat generation does not occur, and a state of the protection device and a circuit or an apparatus to be protected and a state of a surrounding environment thereof are within expected scopes.

The protection device 1 of the present invention can have a large holding current by having the configuration as described above. In the conventional protection device in which the PTC component and the thermal fuse component are connected in parallel with each other, since a resistance value of the thermal fuse component is generally sufficiently lower than a resistance value of the PTC component, a current flows through a circuit including the thermal fuse component side and does not substantively flow through the PTC component. Therefore, a holding current of the conventional protection device is substantively the same as a holding current of the thermal fuse component. Meanwhile, in the protection device of the present invention, since the current flows through both of the PTC component and the thermal fuse component, a load current of the thermal fuse component can be reduced. Therefore, it becomes possible to flow a larger current than the holding current of the thermal fuse component through the protection device, as a result of which the holding current of the protection device is increased.

The protection device 1 of the present invention can interrupt the current flowing therethrough when the excessive current occurs. In particular, since in the protection device 1 of the present invention, the thermal fuse component 4 described above is under the influence of heat of the PTC component 2 described above, the protection device 1 of the present invention can interrupt the current with a good response to the excessive current. Here, “under the influence of heat” means an environment in that when the PTC component trips, a Joule heat generated in the PTC component is transferred to the thermal fuse component to fuse the thermal fuse component or to aid the fusing of the thermal fuse component. Generally, though the thermal fuse component can ultimately fuse when an excessive current over the holding current flows therethrough, its responsiveness is low. For example, it takes a several ten seconds to a several minutes from stating of the flowing of the excessive current to fusing. As described above, by disposing the thermal fuse component such that it is under the influence of heat of the PTC component, the Joule heat generated in the PTC component fuses the thermal fuse component or aids the fusing of the thermal fuse component after the PTC component trips due to the excessive current, so that the responsiveness to the excessive current is improved. In this embodiment, it is preferable that the PTC component activates before the thermal fuse. That is, when the excessive current flows through the protection device 1, the PTC component 2 firstly trips (activates) due to the excessive current, and the current flowing through the PTC component 2 is diverted to the thermal fuse component 4, as a result of which a current over the holding current flows through the thermal fuse component 4 and the thermal fuse component 4 generates heat. Furthermore, by transferring the Joule heat generated in the PTC component 2 which has tripped to the thermal fuse component 4, the thermal fuse component 4 fuses and the current flowing through the protection device 1 is rapidly interrupted.

In this embodiment, a temperature of the PTC component after tripping is preferably higher than an activating temperature of the thermal fuse component. By setting the temperature of the PTC component after tripping to a temperature which is higher the activating temperature of the thermal fuse component, it is possible to more efficiently fuse the thermal fuse component or to aid the fusing.

The protection device 1 of the present invention can interrupt the current flowing therethrough when the abnormal heat generation occurs. Here, the “abnormal heat generation” means that an unexpected heat generation occurs in a circuit or an apparatus or a surround thereof and a surrounding temperature of the protection device reaches the abnormal high temperature. The “surrounding temperature” means a temperature of an atmosphere surrounding a certain component, for example in this case the protection device, or a temperature of other members contacting with the protection device. The “abnormal high temperature” does not mean a specific temperature and is appropriately determined depending on a use, a circuit or an apparatus to be protected or the like. For example, it means a temperature which is higher than a temperature range allowable during a normal operation of the apparatus or a temperature over a rated temperature of a part to be used. When the abnormal heat generation occurs around the protection device 1, the temperature of the PTC component 2 or the thermal fuse component 4 exceeds the activating temperature, and the component (the PTC component 2 or the thermal fuse component 4) which has reached the temperature over the activating temperature activates and interrupts the current; and by diverting the current flowing therethrough to the other component, so that the other component also activates to interrupt the current flowing through the protection device 1. In particular, in the protection device 1 of the present invention, the activating temperature of the protection device can be changed by adjusting the activating temperature of the thermal fuse component. For example, by setting the activating temperature of the thermal fuse component to 80-100° C., it is possible to provide a sure protection against a relatively low temperature, for example 80-100° C., as the abnormal high temperature.

In this embodiment, it is preferable that the thermal fuse component firstly activates. By the thermal fuse component fistly fusing, since the current flowing therethrough can be diverted to the PTC component upon the fusing of the thermal fuse component, so that an arc generation associated with the fusing of the thermal fuse component can be suppressed.

The protection device 1 of the present invention can provide the suitable protection against any of the excessive current or the abnormal heat generation (in the present specification, generally referred to as an “abnormal state”) as described above.

The PTC component used in the protection device of the present invention is not particularly limited, and a conventional PTC component, for example a polymer PTC component and a ceramic PTC component can be used. A preferable PTC component is the polymer PTC component.

The polymer PTC component mentioned above comprises a laminate PTC element which is formed by extruding an electrically conductive composition comprising a polymer (for example, polyethylene, polyvinylidene fluoride, or the like) in which an electrically conductive filler (for example, carbon black, nickel alloy, or the like) is dispersed, and electrodes (for example, metal foil) which are disposed on both sides thereof. It is noted that other element such as a lead may be directly connected to the PTC element, and in this case, the electrode can be omitted.

In the protection device of the present invention, one or more, for example 2, 3 or more PTC components can be used. The two or more PTC components may be same or different. When a plurality of the PTC components is used, they are connected electrically in parallel with each other and electrically in parallel with the thermal fuse component. By using a plurality of the PTC components in parallel, a combined resistance value of the PTC components as a whole can be reduced, and therefore the diverting of the current flowing through the thermal fuse component to the PTC component(s) becomes easier.

The resistance value of the above mentioned PTC component (when a plurality of the PTC components is used, it means the combined resistance value of the PTC components) is not particularly limited, but is 100 mΩ or less, preferably 50 mΩ or less, more preferably 10 mΩ or less, further preferably 5 mΩ or less, for example 0.1-10 mΩ, preferable 0.1-5 mΩ, at 25° C. By setting the resistance value to smaller, the current flowing through the PTC component can be more increased, that is, the rated current of the protection component can be made larger.

The thermal fuse component used in the protection device of the present invention is not particularly limited as long as it is one generally used as a thermal fuse component.

The resistance value of the thermal fuse component is not particularly limited, but is 100 mΩ or less, preferably 50 mΩ or less, more preferably 10 mΩ or less, further preferably 5 mΩ or less, for example 0.1-10 mΩ, preferably 0.1-5 mΩ.

In the protection device of the present invention, by adjusting the combination of the resistance values of the PTC component and the thermal fuse component, the current value flowing through each component can be adjusted.

The activating temperature of the thermal fuse component is not particularly limited, but is within a range of for example 80-200° C., preferably 80-150° C., for example 80-130° C. or 80-100° C. By setting the activating temperature of the thermal fuse component to a relatively low temperature, the protection device of the present invention can respond to the abnormal high temperature which is a relatively low temperature, for example 80-100° C. and interrupt the current.

In one embodiment, the protection device of the present invention may comprise a resistor 6 which is connected electrically in parallel with the PTC component 2 and connected electrically in series with the thermal fuse component 4 as shown in FIG. 2. It is noted that though the number of the resistor is only one in FIG. 2, it is not limited to this, and a plurality of the resistors may be used in series as long as the protection device of the present invention can suitably activate. Preferably, the resistor is disposed so as not to give a thermal influence to the PTC component or the thermal fuse component. By using such resistor, it becomes easy to divert the current flowing through the thermal fuse component 4 to the PTC component 2.

The resistance value of the resistor described above is not particularly limited, but is selected such that the combined resistance with the thermal fuse component described above is 100 mΩ or less, preferably 50 mΩ or less, more preferably 10 mΩ or less, further preferably 5 mΩ or less, for example, 0.1-10 mΩ, preferably 0.1-5 mΩ.

In the protection device of the present invention, the resistance value of the PTC component (when a plurality of the PTC components are present, a combined resistance value thereof is used) and the resistance value of the thermal fuse component (when the resistor is present, a combined resistance value of the thermal fuse component and the resistor) are appropriately selected such that a current flows through both of the PTC component and the thermal fuse component at an operating temperature.

A ratio of the resistance value of the PTC component or a combined resistance value of a plurality of the PTC components (when they are present) to the resistance value of the thermal fuse component or a combined resistance of the thermal fuse component and a resistor (when the resistor is present) is preferably 1:10-10:1, for example 1:5-5:1. The ratio can be appropriately determined depending on the holding currents of the PTC component to be used and the thermal fuse component to be used.

With the protection device of the present invention, the current flows substantively through the PTC component and the thermal fuse component. Preferably, a ratio of a current value flowing through the PTC component (when a plurality of the PTC components is present, a total value thereof) to a current value flowing through the thermal fuse component is 10:1-1:10, for example 5:1-1:5. The ratio can be appropriately determined depending on the holding currents of the PTC component used and the thermal fuse component used.

The protection device of the present invention can rapidly and surely interrupt the excessive current which is 1.2-5 times the rated current of the protection device by adjusting the ratio of the resistance value or the current value described above. In the preferable embodiment, the protection device of the present invention can rapidly and surely interrupt the excessive current even when the excessive current which is 1.2-3.0 times, preferably 1.5-2.0 times the rated current flows.

### INDUSTRIAL APPLICABILITY

The protection device of the present invention has the large holding current and can be suitably used as a protection device for a battery in an apparatus such as a tablet type or notebook type personal computer which requires high discharge current.

### EXPLANATION OF THE REFERENCE NUMERALS

1—protection device

2—PTC component

4—thermal fuse component

6—resistor

1. A protection device comprising
(i) at least one PTC component, and
(ii) a thermal fuse component,
wherein
each of the PTC component and the thermal fuse component are connected to each other electrically in parallel,
the thermal fuse component is under influence of heat of at least one PTC component, and
in a normal state, a current flows substantially through each PTC component and the thermal fuse component.

2. The protection device according to claim 1 comprising two or more PTC components.

3. The protection device according to claim 1 further comprising one or more resistors connected to the PTC component electrically in parallel and connected to the thermal fuse component electrically in series.

4. The protection device according to claim 1 wherein a ratio of a resistance value of the PTC component, to a resistance value of the thermal fuse component is 1:10-10:1.

5. The protection device according to claim 1 wherein a ratio of a total of a current value flowing through each PTC component to a current value flowing through the thermal fuse component is 10:1-1:10.

6. The protection device according to claim 1 wherein when an excessive current flows through the protection device, the PTC component activates, and then the thermal fuse component activates.

7. The protection device according to claim 6 wherein the excessive current is 1.2-5 times a rated current of the protection device.

8. The protection device according to claim 1 wherein when a temperature surrounding the protection device reaches a prescribed temperature or more, the thermal fuse component activates, and then the PTC component activates.

9. An electrical apparatus comprising the protection device according to claim 1.

10. The protection device according to claim 2 further comprising one or more resistors connected to the PTC component electrically in parallel and connected to the thermal fuse component electrically in series.

11. The protection device according to claim 2 wherein a ratio of a combined resistance value of a plurality of the PTC components to a resistance value of the thermal fuse component is 1:10-10:1.

12. The protection device according to claim 3 wherein a ratio of a combined resistance value of a plurality of the PTC components to a combined resistance value of the thermal fuse component and a resistor is 1:10-10:1.

13. The protection device according to claim 2 wherein a ratio of a total of a current value flowing through each PTC component to a current value flowing through the thermal fuse component is 10:1-1:10.

14. The protection device according to claim 2 wherein when an excessive current flows through the protection device, the PTC component activates, and then the thermal fuse component activates.

15. The protection device according to claim 2 wherein when a temperature surrounding the protection device reaches a prescribed temperature or more, the thermal fuse component activates, and then the PTC component activates.

16. The protection device according to claim 3 wherein when a temperature surrounding the protection device reaches a prescribed temperature or more, the thermal fuse component activates, and then the PTC component activates.
